(19) United States
(12) Patent Application Publication
(10) Pub. No.: US 2007/0123629 A1
(43) Pub. Date: May 31, 2007

(54) Post-addition of white minerals for modifications of optical film properties

(76) Inventors: Edward J. Sare, Macon, GA (US); Stephen C. Raper, Byron, GA (US); Julie Figlar, Clemmons, NC (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/587,932

(22) PCT Filed: Dec. 17, 2004
(86) PCT No.: PCT/US04/42164

§ 371 Date: Feb. 2, 2007

Related U.S. Application Data
(60) Provisional application No. 60/541,927, filed on Feb. 6, 2004.

(51) Int. Cl. C08K 3/34; C09B 67/00

(52) U.S. Cl. 524/451; 524/448; 524/447; 523/333

(57) ABSTRACT

The present invention relates to a process for preparing a PVC tinted system, such as a paint. After the preparation of the tinted system, at least one of its optical properties can be adjusted by the addition of at least one white pigment that includes a white pigment other than TiO₂. The optical properties that can be adjusted include at least one of tint strength, opacity, color, and whiteness.

This application claims priority to U.S. Provisional Patent Application No. 60/541,927, filed Feb. 6, 2004.

Optical properties are often used to assess PVC tinted systems, such as dry paint films. One property is the opacity (or “hide”) of the dry paint film. Another property is the “tint strength,” which is a measure of the overall color response to the addition of colorants. Tinted films have been growing in popularity over white paints, such as in the case of the architectural or decorative paint market.

During the manufacture of paints, the optical properties may vary from batch to batch. To ensure a product that reliably has desired optical properties, the paint may undergo a final adjustment of the optical paint properties. For example, to increase the overall tint strength, an adjustment can be made by the post-addition (“post-ad”) of TiO₂ to a reactor batch. Water can be used to lower the tint strength. The addition of TiO₂ can also affect opacity and whiteness.

A disadvantage of using TiO₂ is its cost, and it is often the most expensive primary component of a paint. Accordingly, a need remains to minimize the amount of TiO₂ present in a paint formulation while providing sufficient optical properties, such as at least one property chosen from tint strength, opacity, and whiteness.

### BRIEF DESCRIPTION OF THE DRAWING

FIG. 1 shows a graph of equivalent spherical diameter of calcium carbonate used in Example 8 (μm, x-axis) versus cumulative mass percent (y-axis).

One aspect of the present invention relates to the preparation of PVC tinted systems. “Tinted systems” refer to any colorable media, such as paints, inks, colorable sealants, colorable caulks, grout, synthetic stucco, block filler (a very high PVC paint used to coat concrete block and like surfaces), and plastics. “PVC” is the “pigment volume concentration” and is defined as a percentage of volume of a dried film according to the following equation:

$$PVC = \frac{volume of pigments}{volume of pigments + volume of binder}$$

One aspect of the present invention provides a process for preparing a PVC tinted system, such as a paint, comprising:
providing a first paint having at least one optical property chosen from tint strength, opacity, color, and whiteness; and
combining at least one white pigment with the first paint in an amount effective to form a second paint having at least one optical property of a different value from the at least one optical property of the first paint;
wherein the at least one white pigment includes a white pigment other than TiO₂.

In one aspect, the present invention provides a method of adjusting at least one optical property of a paint after mixing the initial set of paint ingredients. In one aspect, the at least one optical property of the first paint can be measured, and if it is deemed to be optically unacceptable for a particular purpose, the method comprises using at least one white pigment including a white pigment other than TiO₂ for adjusting the optical property. In one aspect, based on the measured at least one optical property, an amount of the at least one white pigment can be determined for combining with the first paint.

The at least one white pigment can include TiO₂ so long as it includes at least one white pigment other than TiO₂. In one aspect, the at least one white pigment can also serve as an extender to partially replace titanium dioxide and other more expensive pigments while imparting at least one optical property chosen from tint strength, opacity, color, and whiteness. In another aspect, the at least one white pigment serves as an extender of the paint itself by replacing a portion of the other paint components, such as TiO₂. The at least one white pigment adds to the bulk of the paint and can allow larger volumes of paint to be produced from a given amount of the replaced portion.

In one aspect, paint formulations contain at least one ingredient chosen from polymeric binders, thickeners, dispersants, and biocides, and may additionally comprise at least one additional ingredient chosen from a primary pigment such as titanium dioxide, at least one secondary pigment such as pigments chosen from hydrous kaolin, fully calcined kaolin, partially calcined kaolin, flash calcined kaolin, delaminated kaolin, calcium carbonate, silica, nephaline syenite, feldspar, dolomite, diatomaceous earth, and flux-calcined diatomaceous earth. For water-based versions of such paint compositions, any water-dispersible binder, such as polyvinyl alcohol (PVA) and acrylics may be used. Paint compositions of the present invention may also comprise other conventional additives, including, but not limited to, surfactants, thickeners, defoamers, wetting agents, dispersants, solvents, and coalescents. Exemplary paints include latex paints, oil-based paints, and acrylic paints.

In one aspect, the at least one optical property is tint strength. Tint strength is a measure of the overall color response to the addition of colorants. Tint strength can be related to the magnitude of ΔE, which is defined below:
ΔE=(ΔL²+Δa²+Δb²)^{1/2}

Components a, b, and L are the color component values on the color space scale and can be measured by a Hunter Ultrascan XE instrument. “+a” is a measure of red tint; “−a” is a measure of green tint; “+b” is a measure of yellow tint; “−b” is a measure of blue tint; “L” is a measure of whiteness.

It can be appreciated that the relative color of the paint can be “lighter” (e.g., less blue) or “darker” (e.g., more blue). In the case of tint strength, the “lighter” colored paint is considered to have the higher tint strength after addition of a darker pigment.

In one aspect, the at least one optical property is whiteness. Alternatively, whiteness can be measured by the ASTM-E-313 standard method. ASTM-E-313 white is a standard measurement, made using an instrument such as the Hunter Ultrascan XE, of the whiteness of near white, opaque film coatings.

In another aspect, the at least one optical property is opacity. Paint film opacity is related to light scattering, which occurs when light travels through two or more different materials, particularly different materials having different refractive indices. In a pigmented paint, light can be scattered by both the pigment and extender, as well as cavities or voids. Thus, to maximize opacity, it is generally desired to maximize light scattering by the pigment/extender and voids or cavities.

In one aspect, the white pigment other than TiO₂ can be chosen from plastic pigments and white minerals, e.g., white inorganic materials. Exemplary white minerals include those minerals chosen from silica (e.g., quartz or cristobalite), calcium carbonate, calcium sulfate, feldspar, diatomaceous earth, flux-calcined diatomaceous earth, limestone, dolomite, chalk, talc, hydrous kaolin, delaminated kaolin, fully calcined kaolin, partially calcined kaolin, flash calcined kaolin, brucite, halloysite, zeolite, smectite, mica, nephyline syenite, aluminum trihydroxide, alumina, zirconia, lead oxide, lead carbonate, zinc oxide, zinc sulfide, barium sulfate, barite, and aluminum silicate. The white mineral can be naturally occurring or synthetic. Exemplary white synthetic minerals include minerals chosen from precipitated calcium carbonate, precipitated magnesium hydroxide, precipitated silica, precipitated barium sulfate, and synthetic aluminum trihydroxide.

In one aspect, the at least one white pigment is chosen from kaolins, such as calcined kaolin, hydrous kaolin, and mixtures thereof. Kaolin clay comprises predominantly of the mineral kaolinite, together with small proportions of various impurities. The kaolin can be processed by any method known to one of ordinary skill in the art. In one aspect, the kaolin is delaminated kaolin. In other aspects, the kaolin may comprise calcined kaolin such as a partially calcined kaolin, a fully calcined kaolin, or a flash calcined kaolin.

In one aspect, the at least one white pigment comprises calcium carbonate. Calcium carbonate can exist in many forms, such as ground calcium carbonate or precipitated carbonate. Precipitated carbonates can be generated by a variety of known methods, such as by chemically precipitating a low solids aqueous suspension, e.g., having a solids concentration less than 25% by weight. The particles may be predominantly of a certain crystal form, which in turn affects the particle shape; e.g., scalenohedral, rhombohedral or aragonite, obtained by applying known reaction conditions, which favor the growth of crystals of the desired form. The particles may be the product of a reaction of gaseous carbon dioxide with calcium hydroxide in a slaked lime suspension in a manner well known to those skilled in the art. Ground calcium carbonate particles can be prepared by any known method, such as by conventional grinding and classifying techniques, e.g. jaw crushing followed by roller milling or hammer milling and air classifying.

In one aspect, the at least one white pigment can comprise a white plastic pigment. Exemplary plastic pigments include, for example, the ROPAQUE™ opaque polymers available from Rohm and Haas. Suitable plastic pigments generally include beads comprising homopolymers and copolymers comprising monomers chosen from acrylate monomers, alkyl acrylate monomers, ester monomers, vinyl monomers, and styrene monomers. In one aspect, a suitable white plastic pigment can comprise an emulsion of spherical styrene/acrylic beads. For example, in wet paints, the beads are filled with water. As the paints dry, water can permanently diffuse from the center of the beads and can be replaced by air, resulting in discrete encapsulated air voids uniformly dispersed throughout the dry paint film. The encapsulated air voids can provide optimal hiding when the paint film dries and light is scattered as it passes from the exterior of the beads to the interior microvoids.

In one aspect, the at least one white pigment can be in dry or slurry form when combined with the first paint. Where the white pigment is a white mineral, the white mineral can be wet-ground or dry-ground.

In one aspect, the paint has a desired pigment volume concentration. In one aspect, the paint has a pigment volume concentration ranging from about 40% to about 70%, such as a range from about 40% to about 50%, from about 50% to about 60%, or from about 60% to about 70%. In another aspect, the paint has a pigment volume concentration of at least about 70%, such as a PVC ranging from about 70% to about 85%.

The PVC can be affected by using the white pigment other than TiO₂. For example, the weight of titanium dioxide added, which can be approximately about 5 to about 30 pounds/100 gallons of the initial paint formulation, can be about half that used for each of the non-titanium dioxide pigments, e.g., about 5 to about 60 pounds/100 gallons of the initial paint formulation. This is in part due to the fact that the price of titanium dioxide is considerably higher than any of the other pigments tested, i.e., from about two to about ten times higher. The density of TiO₂, however, is considerably higher than that of most other pigments used in architectural paint formulations. The density of TiO₂ (usually coated rutile or anatase) used in the architectural paint market is about 4 g/ml. In contrast, it can also be seen that the densities of the other pigments are all substantially lower (e.g., nominal densities of 2.5+ g/ml), which can lead to at least two consequences. First, the net effect of the post addition of these pigments on the PVC of the final paint differs. Second, the final volume of the paint differs.

The PVC can be selected according to the selected pigment, as appreciated by one of ordinary skill in the art. In one aspect, the present invention provides a process for preparing a paint, comprising:
providing a first paint having at least one optical property, the first paint having a pigment volume concentration ranging from about 50% to about 60% and the at least one optical property being chosen from tint strength, opacity, color, and whiteness;
combining talc with the first paint in an amount effective to form a second paint having at least one optical property of a different value from the at least one optical property of the first paint.

In another aspect, the present invention provides a process for preparing a paint, comprising:
providing a first paint having at least one optical property, the first paint having a pigment volume concentration ranging from about 35% to about 70% and the at least one optical property being chosen from tint strength, opacity, color, and whiteness;
combining calcined kaolin with the first paint in an amount effective to form a second paint having at least one optical property of a different value from the at least one optical property of the first paint.

In another aspect, the present invention provides a process for preparing a paint, comprising:
providing a first paint having at least one optical property, the first paint having a pigment volume concentration of at least about 70% and the at least one optical property being chosen from tint strength, opacity, color, and whiteness;
combining hydrous kaolin with the first paint in an amount effective to form a second paint having at least one optical property of a different value from the at least one optical property of the first paint.

In another aspect, the present invention provides a process for preparing a paint, comprising:
providing a first paint having at least one optical property, the first paint having a pigment volume concentration ranging from about 60% to about 70% and the at least one optical property being chosen from tint strength, opacity, color, and whiteness;
combining calcium carbonate with the first paint in an amount effective to form a second paint having at least one optical property of a different value from the at least one optical property of the first paint.

In another aspect, the present invention provides a process for preparing a paint, comprising:
providing a first paint having at least one optical property, the first paint having a pigment volume concentration of at least about 70% and the at least one optical property being chosen from tint strength, opacity, color, and whiteness;
combining feldspar with the first paint in an amount effective to form a second paint having at least one optical property of a different value from the at least one optical property of the first paint.

In another aspect of the present invention, the at least one white pigment other than TiO2 can be a blend of at least two white pigments, as described herein, such as a blend of at least two white minerals. In one aspect, the blend can comprise calcined kaolin and calcium carbonate. Another aspect of the present invention provides a process for preparing a paint, comprising:
providing a first paint having at least one optical property, the first paint having a pigment volume concentration of at least about 70% and the at least one optical property being chosen from tint strength, opacity, color, and whiteness;
combining calcium carbonate and kaolin with the first paint in an amount effective to form a second paint having at least one optical property of a different value from the at least one optical property of the first paint.

Another method for assessing the properties of a paint is determining the critical pigment volume concentration, or CPVC. CPVC is that PVC at which there is sufficient binder to wet the pigment. One pigment property that can be indicative of the effect of a pigment on the CPVC is oil absorption. One technique to determine oil absorption is the Spatula Rub-out Oil Absorption Test (ASTM D-281). In one aspect, the paint has a PVC greater than CPVC. In another aspect, the paint has a PVC below CPVC.

Oil absorption refers to the number of grams of oil absorbed by 100 grams of the pigment (units of g/g, indicated as a %) and is traditionally considered to be an indication of the total resin of the pigment. Oil absorption is dependent on particle structure, interparticle packing, and particle size. Higher oil absorption indicates higher resin demand, which can lead to, for example, increased opacity. Addition of a high resin demand pigment at a PVC near the CPVC of that paint, can have enhanced effects on optical properties.

In one aspect, the at least one white pigment has an oil absorption of at least about 100%, such as an oil absorption of at least about 110%.

The invention will be further clarified by the following non-limiting examples, which are intended to be purely exemplary of the invention.

### EXAMPLE 1

This Example describes the effects of post-addition of white pigments other than TiO₂ as compared to post-addition with TiO₂. The relative tint strength was measured using a standard phthalo blue pigment dispersion. The difference in the color of the paints after tinting is a measure of the overall tint strength of the paint. As can be seen, all tint strengths were calculated relative to the initial formulation. The pigment volume concentration (PVC) used in this Example are those typically employed for architectural flat interior wall paints, e.g., 44% PVC, 55% PVC, 65% PVC, and 75% PVC. In each formulation, the initial level of TiO₂ is representative of commercial formulations. Table I below shows the initial formulations for the 44% PVC, 55% PVC, 65% PVC, and 75% PVC paints.

TABLE I

| Paint Components | 44% PVC | 55% PVC | 65% PVC | 75% PVC |
|---|---|---|---|---|
| Water | 290.0 | 342.4 | 339.9 | 339.8 |
| KTPP | 1.8 | 1.8 | 1.8 | 1.8 |
| Dispersant | 7.9 | 8.0 | 7.8 | 7.8 |
| Surfactant | 4.0 | 4.0 | 3.9 | 3.9 |
| Defoamer | 3.0 | 3.0 | 2.9 | 2.9 |
| TiO₂ | 143.6 | 91.0 | 73.4 | 68.5 |
| Calcium Carbonate | 96.3 | 125.6 | 264.3 | 281.8 |
| Calcined Kaolin | 148.9 | 208.9 | 211.9 | 244.8 |
| Cellulose Thickener | 4.0 | 4.5 | 3.9 | 4.9 |
| Latex | 338.6 | 249.9 | 213.5 | 146.9 |
| Ethylene Glycol | 24.8 | 25.0 | 24.5 | 24.5 |
| Alcohol | 9.9 | 10.0 | 9.8 | 9.8 |
| Water | 45.7 | 55.0 | 45.0 | 88.7 |

Tables II and III summarize the properties of the pigments used for post-addition in this example, i.e., crystalline silica (quartz), feldspar, flux-calcined diatomaceous earth, calcium carbonate, hydrous kaolin, and calcined kaolin.

TABLE II

| | | | | Flux-Calcined | | |
|---|---|---|---|---|---|---|
| | | Crystalline | | Diatomaceous | Calcium | Calcium |
| | TiO₂ | Silica | Feldspar | Earth | Carbonate A | Carbonate B |
| L | | 93.6 | 95.8 | 95.4 | 97.9 | 96.7 |
| a | | 0.1 | −0.3 | −0.4 | −0.2 | −0.3 |
| b | | 2.5 | 1.1 | 2.0 | 0.4 | 1.1 |
| Brightness | | 85.5 | 92.0 | 90.0 | 97.0 | 93.8 |
| Oil | 22 | 31 | 42 | 148 | 32 | 22 |
| Absorption | | | | | | |
| Density | 4.0 | 2.6 | 2.7 | 2.3 | 2.7 | 2.7 |
| % <10 μm | Median | — | 97 | 89 | 98 | 42 |
| % <5 μm | Particle | 35 | 87 | 55 | 94 | 22 |
| % <2 μm | Size | 21 | 48 | 9 | 81 | 9 |
| % <1 μm | 0.3 μm | 13 | 21 | 2 | 53 | 4 |
| % <0.5 μm | (Supplier | 6 | 4 | 1 | 26 | 2 |
| | Reference) | | | | | |

TABLE III

| | | Hydrous | Calcined | Calcined | Calcined |
|---|---|---|---|---|---|
| | Talc | Kaolin | Kaolin A | Kaolin B | Kaolin C |
| L | 93.7 | 95.9 | 91.2 | 97.0 | 96.7 |
| a | −0.9 | −0.4 | −0.6 | −0.6 | −0.7 |
| b | 1.2 | 2.6 | 2.3 | 3.0 | 2.1 |
| Brightness | 87.8 | 90.1 | 93.2 | 91.7 | 92.4 |
| Oil Absorption | 56 | 69 | 124 | 70 | 88 |
| Density | 2.8 | 2.6 | 2.6 | 2.6 | 2.6 |
| % <10 μm | — | 99 | 99 | 99 | 99 |
| % <5 μm | — | 98 | 97 | 92 | 83 |
| % <2 μm | — | 97 | 91 | 66 | 56 |
| % <1 μm | — | 95 | 79 | 43 | 41 |
| % <0.5 μm | — | 86 | 23 | 10 | 10 |

Table IV summarizes the overall effect of post addition of these pigments on tint strength and opacity of the formulations used. In the following examples, ΔE is used as an indicator of the magnitude of the tint change resulting from addition of the relevant pigment.

TABLE IV

| | | | Non-Calcined | Calcined |
|---|---|---|---|---|
| | PVC | TiO₂ | Pigments | Kaolins |
| Opacity | 44% | ≲0.5 | ≲0.5 | ≲0.5 |
| Tint Strength, | | ≲1.0 | ≲0.5 | ≲1.5 |
| ΔE | | | | |
| Opacity | 55% | ≲0.5 | ≲1.0 | ≲1.5 |
| Tint Strength, | | ≲1.5 | ≲1.0 | ≲2.5 |
| ΔE | | | | |
| Opacity | 65% | ≲1.0 | ≲1.0 | ≲1.5 |
| Tint Strength, | | ≲1.0 | ≲1.5 | ≲2.0 |
| ΔE | | | | |
| Opacity | 75% | ≲0.5 | ≲1.0 | ≲1.0 |
| Tint Strength, | | ≲0.5 | ≲1.0 | ≲1.0 |
| ΔE | | | | |

Generally, the calcined kaolins show a very high degree of post-ad tint strength efficacy versus the significantly more expensive titanium dioxide. This is particularly evident at pigment volume concentrations at or above the critical pigment volume concentration. It can be seen that several of the “non-calcined pigments” also exhibit levels of optical efficiency comparable to titanium dioxide.

Table V summarizes the overall change in tint strength as measured by the ΔE parameter for the twelve pigments used in this Example for each of the four formulations.

TABLE V

| | | ΔE | ΔE | ΔE | ΔE |
|---|---|---|---|---|---|
| | Weight | 44% | 55% | 65% | 75% |
| | (lbs/100 gal) | PVC | PVC | PVC | PVC |
| TiO₂ | 14 | 0.9 | 1.3 | 1.0 | 0.2 |
| Plastic | 30 | 0.1 | 0.9 | 0.2 | 0.8 |
| Crystalline Silica | 30 | 0.2 | 0.6 | 0.1 | 0.4 |
| Feldspar | 30 | 0.2 | 0.6 | 0.6 | 0.8 |
| Flux Calcined | 30 | 0.3 | 0.6 | 0.4 | 0.4 |
| Diatomaceous Earth | | | | | |
| Calcium Carbonate A | 30 | 0.2 | 0.7 | 1.3 | 0.6 |
| Calcium Carbonate B | 30 | 0.1 | 0.3 | 1.4 | 0.2 |
| Talc | 30 | 0.2 | 1.6 | 0.7 | 0.5 |
| Hydrous Kaolin | 30 | 0.1 | 0.6 | 0.5 | 1.4 |
| Calcined Kaolin A | 30 | 1.3 | 2.4 | 1.8 | 0.8 |
| Calcined Kaolin B | 30 | 0.4 | 1.0 | 1.1 | 0.4 |
| Calcined Kaolin C | 30 | 0.7 | 1.7 | 1.7 | 0.7 |

In Table VI, the weight of titanium dioxide added is approximately about 0 to about 14 pounds/100 gallons of the initial paint formulation, which is about half that used for each of the non-titanium dioxide pigments, e.g., about 0 to about 30 pounds/100 gallons of the initial paint formulation. Because the cost of TiO₂ is more than 2× that of the other pigments, the overall cost of using the other pigments can be comparable or even lower that that of TiO₂. Additionally, the density of TiO₂, however, is considerably higher than that of most other pigments used in architectural paint formulations, thereby lowering the PVC. The amount of pigment added is summarized in the Table VI, below.

TABLE VI
Relative Pigment Volume¹ Added

| | Pigment Weight (lbs/100 Gallons) | | | | | | | |
|---|---|---|---|---|---|---|---|---|
| | 3.5 | 7 | 7.5 | 10.5 | 14 | 15 | 22.5 | 30 |
| TiO₂ | 0.10 | 0.21 | — | 0.31 | 0.42 | — | — | — |
| Plastic | — | — | 0.87 | — | — | 1.75 | 2.51 | 3.49 |
| Pigment | | | | | | | | |
| Crystalline | — | — | 0.34 | — | — | 0.68 | 1.02 | 1.36 |
| Silica | | | | | | | | |
| Feldspar | — | — | 0.33 | — | — | 0.67 | 1.00 | 1.33 |
| Flux Calcined | — | — | 0.39 | — | — | 0.78 | 1.17 | 1.56 |
| Calcium | — | — | 0.33 | — | — | 0.67 | 1.00 | 1.33 |
| Carbonate | | | | | | | | |
| Talc | — | — | 0.32 | — | — | 0.64 | 0.96 | 1.28 |
| Hydrous | — | — | 0.35 | — | — | 0.69 | 1.04 | 1.38 |
| Kaolin | | | | | | | | |
| Calcined | — | — | 0.34 | — | — | 0.68 | 1.03 | 1.37 |
| Kaolin | | | | | | | | |

¹Gallons

As a consequence of these differences in final volume, the overall effectiveness of the non-TiO₂ pigments is further enhanced. In fact as shown in the Table below, the overall efficiency in terms of the final paint may be significantly greater than TiO₂, a result which is surprising to even those “(skilled in the art.” As can be seen, there is the potential for one of the non-TiO₂ pigment additives to offer significantly greater overall value when the effect on the tint strength is comparable to that of TiO2.

### EXAMPLE 2

This Example shows a comparison of a 44% PVC paint prepared by the post-addition of Calcined Kaolin A, as compared with post-addition of TiO₂ alone, as summarized in Table Vll below.

TABLE VII

| Titanium Dioxide Control - 44% PVC | | | | | Calcined Kaolin A - 44% PVC | | | | |
|---|---|---|---|---|---|---|---|---|---|
| Weight (lbs/100 Gallons Paint I) | | | | | | | | | |
| 0¹ | 3.5 | 7.0 | 10.5 | 14.0 | 0¹ | 7.5 | 15.0 | 22.5 | 30.0 |
| PVC After Addition Paint I | | | | | | | | | |
| 43.8% | 44.0% | 44.1% | 44.3% | 44.5% | 43.8% | 44.0% | 44.1% | 44.3% | 44.5% |

Paint² Film Property Summary

| | | | | | | | | | | |
|---|---|---|---|---|---|---|---|---|---|---|
| 60° Gloss³ | 4.1 | 4.0 | 3.6 | 3.8 | 3.8 | 4.1 | 3.6 | 3.4 | 3.3 | 3.3 |
| 85° Sheen³ | 6.4 | 6.9 | 6.8 | 7.3 | 7.3 | 6.4 | 7.1 | 7.2 | 7.3 | 7.5 |
| L⁴ | 95.3 | 95.4 | 95.4 | 95.5 | 95.4 | 95.3 | 95.4 | 95.3 | 95.3 | 95.4 |
| a⁴ | −1.0 | −1.0 | −1.0 | −1.0 | −1.0 | −1.0 | −1.0 | −1.0 | −1.0 | −1.0 |
| b⁴ | 1.0 | 1.0 | 1.0 | 1.0 | 1.0 | 1.0 | 1.1 | 1.1 | 1.1 | 1.1 |
| ASTM-E- | 86.7 | 87.0 | 87.1 | 87.3 | 87.4 | 86.7 | 86.6 | 86.4 | 86.3 | 86.3 |
| 313 White⁴ | | | | | | | | | | |
| ASTM-E- | 1.1 | 1.1 | 1.1 | 1.1 | 1.0 | 1.1 | 1.2 | 1.2 | 1.2 | 1.3 |
| 313 | | | | | | | | | | |
| Yellow⁴ | | | | | | | | | | |
| Brightness⁴ | 89.9 | 90.2 | 90.2 | 90.3 | 90.3 | 89.9 | 90.1 | 89.8 | 89.9 | 90.1 |
| Opacity | 95.1 | 95.0 | 95.2 | 95.2 | 95.4 | 95.1 | 95.2 | 94.8 | 95.1 | 95.4 |

Tinted⁵ Film Property Summary

| | | | | | | | | | | |
|---|---|---|---|---|---|---|---|---|---|---|
| L⁴ | 76.4 | 76.6 | 76.8 | 76.9 | 77.0 | 76.4 | 76.5 | 76.7 | 76.8 | 77.1 |
| a⁴ | −11.1 | −11.0 | −11.0 | −11.0 | −10.9 | −11.1 | −11.1 | −11.0 | −10.9 | −10.8 |
| b⁴ | −21.8 | −21.6 | −21.5 | −21.3 | −21.2 | −21.8 | −21.6 | −21.5 | −21.2 | −20.8 |
| Δ L | — | −0.2 | −0.4 | −0.5 | −0.6 | — | −0.1 | −0.3 | −0.4 | −0.7 |
| Δ a | — | −0.1 | −0.1 | −0.1 | −0.2 | — | 0.0 | −0.1 | −0.2 | −0.3 |
| Δ b | — | −0.2 | −0.3 | −0.5 | −0.6 | — | −0.2 | −0.3 | −0.6 | −1.0 |
| Δ E | — | 0.3 | 0.5 | 0.7 | 0.9 | — | 0.2 | 0.4 | 0.7 | 1.3 |

¹Paint I
²3-mil wet drawdown
³Hunter Pro-3 Gloss Meter
⁴Hunter UltraScan XE
⁵11 pounds phthalo blue dispersion

It can be seen that the overall tint strength as measured by the AE parameter is improved with the calcined kaolin post-addition compared to that with post-addition of TiO₂ alone.

TABLE VIII

| Titanium Dioxide Control - 55% PVC | | | | | Talc - 55% PVC | | | | |
|---|---|---|---|---|---|---|---|---|---|
| Weight (lbs/100 Gallons Paint I) | | | | | | | | | |
| 0¹ | 3.5 | 7.0 | 10.5 | 14.0 | 0¹ | 7.5 | 15.0 | 22.5 | 30.0 |
| PVC After Addition Paint I | | | | | | | | | |
| 55.0% | 55.2% | 55.4% | 55.5% | 55.7% | 55.0% | 55.5% | 55.9% | 56.3% | 56.8% |

Paint² Film Property Summary

| | | | | | | | | | | |
|---|---|---|---|---|---|---|---|---|---|---|
| 60° Gloss³ | 2.8 | 2.9 | 2.9 | 2.9 | 2.9 | 2.9 | 2.9 | 2.9 | 2.9 | 2.9 |
| 85° Sheen³ | 4.3 | 4.5 | 4.7 | 4.7 | 4.7 | 4.3 | 4.6 | 4.7 | 5.3 | 5.1 |
| L⁴ | 94.9 | 94.8 | 94.8 | 94.9 | 95.1 | 94.9 | 94.9 | 94.8 | 94.9 | 95.1 |
| a⁴ | −0.9 | −0.9 | −0.9 | −0.9 | −0.8 | −0.8 | −0.8 | −0.8 | −0.8 | −0.8 |
| b⁴ | 1.3 | 1.2 | 1.2 | 1.2 | 1.2 | 1.3 | 1.3 | 1.3 | 1.2 | 1.2 |
| ASTM-E- | 84.1 | 84.1 | 84.1 | 84.3 | 84.8 | 84.1 | 84.2 | 84.1 | 84.4 | 84.9 |
| 313 White⁴ | | | | | | | | | | |
| ASTM-E- | 1.8 | 1.8 | 1.8 | 1.8 | 1.7 | 1.8 | 1.8 | 1.8 | 1.8 | 1.7 |
| 313 | | | | | | | | | | |
| Yellow⁴ | | | | | | | | | | |
| Brightness⁴ | 88.7 | 88.6 | 88.7 | 88.8 | 89.2 | 88.7 | 88.8 | 88.7 | 88.8 | 89.2 |
| Opacity | 95.6 | 95.5 | 95.7 | 95.9 | 96.1 | 95.6 | 96.0 | 96.4 | 96.9 | 96.8 |

Tinted⁵ Film Property Summary

| | | | | | | | | | | |
|---|---|---|---|---|---|---|---|---|---|---|
| L⁴ | 76.4 | 76.5 | 76.8 | 76.9 | 77.4 | 76.4 | 76.7 | 76.4 | 77.4 | 77.5 |
| a⁴ | −10.7 | −10.7 | −10.6 | −10.6 | −10.5 | −10.7 | −10.6 | −10.7 | −10.4 | −10.4 |
| b⁴ | −20.9 | −20.8 | −20.6 | −20.4 | −20.1 | −20.9 | −20.6 | −20.8 | −20.0 | −19.8 |
| Δ L | — | −0.1 | −0.4 | −0.5 | −1.0 | — | −0.3 | 0.0 | −1.0 | −1.1 |
| Δ a | — | 0.0 | −0.1 | −0.1 | −0.2 | — | −0.1 | 0.0 | −0.3 | −0.3 |
| Δ b | — | −0.1 | −0.3 | −0.5 | −0.8 | — | −0.3 | −0.1 | −0.9 | −1.1 |
| Δ E | — | 0.1 | 0.5 | 0.7 | 1.3 | — | 0.4 | 0.1 | 1.4 | 1.6 |

¹Paint I
²3-mil wet drawdown
³Hunter Pro-3 Gloss Meter
⁴Hunter UltraScan XE
⁵11 pounds phthalo blue dispersion

### EXAMPLE 3

This Example shows a comparison of a 55% PVC paint prepared by post-addition of talc as compared with post-addition of TiO2 alone, as summarized in Table VIII below.

It can be seen that the overall tint strength as measured by the AE parameter is improved with the talc post-addition compared to that with post addition of TiO₂ alone. It can also be seen that the overall whiteness as measured by ASTM E313, and also the opacity, have been improved.

### EXAMPLE 4

This Example shows a comparison of a 55% PVC paint prepared by post-addition of Calcined Kaolin A as compared with post-addition of TiO₂ alone, as summarized in Table IX below.

TABLE IX

| Titanium Dioxide Control - 55% PVC | | | | | Calcined Kaolin A - 55% PVC | | | | |
|---|---|---|---|---|---|---|---|---|---|
| Weight (lbs/100 Gallons Paint I) | | | | | | | | | |
| 0¹ | 3.5 | 7.0 | 10.5 | 14.0 | 0¹ | 7.5 | 15.0 | 22.5 | 30.0 |
| PVC After Addition Paint I | | | | | | | | | |
| 55.0% | 55.2% | 55.4% | 55.5% | 55.7% | 55.0% | 56.0% | 57.0% | 57.9% | 58.9% |

Paint² Film Property Summary

| | | | | | | | | | | |
|---|---|---|---|---|---|---|---|---|---|---|
| 60° Gloss³ | 2.8 | 2.9 | 2.9 | 2.9 | 2.9 | 2.8 | 2.9 | 2.9 | 2.9 | 3.0 |
| 85° Sheen³ | 4.3 | 4.5 | 4.7 | 4.7 | 4.7 | 4.3 | 4.9 | 5.3 | 5.6 | 6.1 |
| L⁴ | 94.9 | 94.8 | 94.8 | 94.9 | 95.1 | 94.9 | 94.9 | 95.0 | 95.1 | 95.2 |
| a⁴ | −0.9 | −0.9 | −0.9 | −0.9 | −0.8 | −0.8 | −0.8 | −0.8 | −0.8 | −0.8 |
| b⁴ | 1.3 | 1.2 | 1.2 | 1.2 | 1.2 | 1.3 | 1.3 | 1.3 | 1.3 | 1.3 |
| ASTM-E- | 84.1 | 84.1 | 84.1 | 84.3 | 84.8 | 84.1 | 84.1 | 84.3 | 84.4 | 84.7 |
| 313 White⁴ | | | | | | | | | | |
| ASTM-E- | 1.8 | 1.8 | 1.8 | 1.8 | 1.7 | 1.8 | 1.9 | 1.9 | 1.9 | 1.9 |
| 313 | | | | | | | | | | |
| Yellow⁴ | | | | | | | | | | |
| Brightness⁴ | 88.7 | 88.6 | 88.7 | 88.8 | 89.2 | 88.7 | 88.7 | 88.9 | 88.1 | 89.3 |
| Opacity | 95.6 | 95.5 | 95.7 | 95.9 | 96.1 | 95.6 | 95.7 | 96.0 | 96.2 | 96.8 |

Tinted⁵ Film Property Summary

| | | | | | | | | | | |
|---|---|---|---|---|---|---|---|---|---|---|
| L⁴ | 76.4 | 76.5 | 76.8 | 76.9 | 77.4 | 76.4 | 76.7 | 77.2 | 77.7 | 78.1 |
| a⁴ | −10.7 | −10.7 | −10.6 | −10.6 | −10.5 | −10.7 | −10.7 | −10.5 | −10.4 | −10.2 |
| b⁴ | −20.9 | −20.8 | −20.6 | −20.4 | −20.1 | −20.9 | −20.6 | −20.2 | −19.8 | −19.3 |
| Δ L | — | −0.1 | −0.4 | −0.5 | −1.0 | — | −0.3 | −0.8 | −1.3 | −1.7 |
| Δ a | — | 0.0 | −0.1 | −0.1 | −0.2 | — | 0.0 | −0.2 | −0.3 | −0.5 |
| Δ b | — | −0.1 | −0.3 | −0.5 | −0.8 | — | −0.3 | −0.7 | −1.1 | −1.6 |
| Δ E | — | 0.1 | 0.5 | 0.7 | 1.3 | — | 0.4 | 1.1 | 1.7 | 2.4 |

¹Paint I
²3-mil wet drawdown
³Hunter Pro-3 Gloss Meter
⁴Hunter UltraScan XE
⁵11 pounds phthalo blue dispersion

It can be seen that the overall tint strength as measured by the ΔE parameter is improved with the calcined kaolin post-addition compared to that with post addition of TiO₂ alone.

TABLE X

| Titanium Dioxide Control - 65% PVC | | | | | Calcium Carbonate A - 65% PVC | | | | |
|---|---|---|---|---|---|---|---|---|---|
| Weight (lbs/100 Gallons Paint I) | | | | | | | | | |
| 0¹ | 3.5 | 7 | 10.5 | 14 | 0¹ | 7.5 | 15.0 | 22.5 | 30.0 |
| PVC After Addition Paint I | | | | | | | | | |
| 65.5% | 65.6% | 65.7% | 65.8% | 65.9% | 65.5% | 65.8% | 66.1% | 66.4% | 66.7% |

Paint² Film Property Summary

| | | | | | | | | | | |
|---|---|---|---|---|---|---|---|---|---|---|
| 60° Gloss³ | 2.8 | 2.8 | 2.8 | 2.8 | 2.8 | 2.8 | 2.7 | 2.8 | 2.8 | 2.8 |
| 85° Sheen³ | 1.7 | 1.7 | 1.7 | 1.7 | 1.7 | 1.7 | 1.6 | 1.7 | 1.7 | 2.1 |
| L⁴ | 95.0 | 95.0 | 95.1 | 95.1 | 95.2 | 95.0 | 94.9 | 94.9 | 94.9 | 95.2 |
| a⁴ | −1.0 | −1.0 | −1.0 | −1.0 | −1.0 | −1.0 | −1.0 | −1.0 | −1.0 | −1.0 |
| b⁴ | 1.6 | 1.7 | 1.6 | 1.6 | 1.6 | 1.6 | 1.6 | 1.6 | 1.6 | 1.6 |
| ASTM-E- | 82.3 | 82.3 | 82.6 | 82.6 | 83.2 | 82.3 | 82.2 | 82.2 | 82.5 | 82.8 |
| 313 White⁴ | | | | | | | | | | |
| ASTM-E- | 2.2 | 2.2 | 2.2 | 2.2 | 2.1 | 2.2 | 2.2 | 2.2 | 2.1 | 2.1 |
| 313 | | | | | | | | | | |
| Yellow⁴ | | | | | | | | | | |
| Brightness⁴ | 88.5 | 88.5 | 88.7 | 88.7 | 89.0 | 88.5 | 88.3 | 88.4 | 88.5 | 88.9 |
| Opacity | 94.2 | 94.5 | 94.5 | 95.0 | 94.8 | 94.2 | 93.5 | 93.3 | 93.4 | 94.5 |

Tinted⁵ Film Property Summary

| | | | | | | | | | | |
|---|---|---|---|---|---|---|---|---|---|---|
| L⁴ | 75.4 | 75.8 | 76.0 | 75.9 | 76.2 | 75.4 | 75.5 | 75.9 | 76.2 | 76.4 |
| a⁴ | −11.5 | −11.4 | −11.3 | −11.3 | −11.2 | −11.5 | −11.4 | −11.3 | −11.2 | −11.2 |
| b⁴ | −22.0 | −21.7 | −21.5 | −21.5 | −21.4 | −22.0 | −21.7 | −21.5 | −21.2 | −21.2 |
| Δ L | — | −0.4 | −0.6 | −0.5 | −0.8 | — | −0.1 | −0.5 | −0.8 | −1.0 |
| Δ a | — | −0.1 | −0.2 | −0.2 | −0.3 | — | −0.1 | −0.2 | −0.3 | −0.3 |
| Δ b | — | −0.3 | −0.5 | −0.5 | −0.6 | — | −0.3 | −0.5 | −0.8 | −0.8 |
| Δ E | — | 0.5 | 0.8 | 0.7 | 1.0 | — | 0.3 | 0.7 | 1.2 | 1.3 |

¹Paint I
²3-mil wet drawdown
³Hunter Pro-3 Gloss Meter
⁴Hunter UltraScan XE
⁵11 pounds phthalo blue dispersion

### EXAMPLE 5

This Example shows a comparison of a 65% PVC paint prepared by post-addition of Calcium Carbonate A as compared with post-addition of TiO₂ alone, as summarized in Table X below.

It can be seen that the overall tint strength as measured by the ΔE parameter is improved with the calcium carbonate post-addition compared to that with post addition of TiO₂ alone. It can also be seen that the overall whiteness as measured by ASTM E313 has also been improved.

### EXAMPLE 6

This Example shows a comparison of a 75% PVC paint prepared by post-addition of feldspar as compared with post-addition of TiO₂ alone, as summarized in Table Xl below.

TABLE XI

| Titanium Dioxide Control - 75% PVC | | | | | Feldspar - 75% PVC | | | | |
|---|---|---|---|---|---|---|---|---|---|
| Weight (lbs/100 Gallons Paint I) | | | | | | | | | |
| 0¹ | 3.5 | 7.0 | 10.5 | 14.0 | 0¹ | 7.5 | 15.0 | 22.5 | 30.0 |
| PVC After Addition Paint I | | | | | | | | | |
| 75.0% | 75.1% | 75.2% | 75.3% | 75.4% | 75.0% | 75.2% | 75.4% | 75.5% | 75.7% |

Paint² Film Property Summary

| | | | | | | | | | | |
|---|---|---|---|---|---|---|---|---|---|---|
| 60° Gloss³ | 3.0 | 3.0 | 3.0 | 3.0 | 1.3 | 3.0 | 3.0 | 3.0 | 3.0 | 3.0 |
| 85° Sheen³ | 5.4 | 5.2 | 5.0 | 5.0 | 4.6 | 5.4 | 6.3 | 6.6 | 6.3 | 7.7 |
| L⁴ | 95.2 | 95.2 | 95.2 | 95.2 | 95.2 | 95.2 | 95.5 | 95.5 | 95.4 | 95.3 |
| a⁴ | −0.7 | −0.7 | −0.7 | −0.7 | −0.7 | −0.7 | −0.7 | −0.7 | −0.7 | −0.7 |
| b⁴ | 1.3 | 1.3 | 1.3 | 1.3 | 1.3 | 1.3 | 1.4 | 1.4 | 1.4 | 1.3 |
| ASTM-E- | 84.4 | 84.5 | 84.6 | 84.7 | 84.9 | 84.4 | 85.0 | 84.9 | 84.6 | 84.9 |
| 313 White⁴ | | | | | | | | | | |
| ASTM-E- | 2.0 | 2.0 | 2.0 | 1.9 | 1.9 | 2.1 | 2.1 | 2.1 | 2.1 | 2.0 |
| 313 | | | | | | | | | | |
| Yellow⁴ | | | | | | | | | | |
| Brightness⁴ | 89.1 | 89.1 | 89.2 | 89.2 | 89.4 | 89.1 | 89.8 | 89.7 | 89.4 | 89.5 |
| Opacity | 97.9 | 98.0 | 98.1 | 98.2 | 98.3 | 97.9 | 99.4 | 99.2 | 99.1 | 98.2 |

Tinted⁵ Film Property Summary

| | | | | | | | | | | |
|---|---|---|---|---|---|---|---|---|---|---|
| L⁴ | 79.3 | 79.3 | 79.3 | 79.3 | 79.3 | 79.3 | 79.1 | 79.0 | 78.9 | 78.9 |
| a⁴ | −9.6 | −9.6 | −9.6 | −9.6 | −9.6 | −9.6 | −9.6 | −9.6 | −9.7 | −9.7 |
| b⁴ | −17.6 | −17.7 | −17.8 | −17.8 | −17.8 | −17.6 | −17.9 | −18.0 | −18.2 | −18.2 |
| Δ L | — | 0.0 | 0.0 | 0.0 | 0.0 | — | 0.2 | 0.3 | 0.4 | 0.4 |
| Δ a | — | 0.0 | 0.0 | 0.3 | 0.0 | — | 0.0 | 0.0 | 0.1 | 0.1 |
| Δ b | — | 0.1 | 0.2 | 0.2 | 0.2 | — | 0.3 | 0.4 | 0.6 | 0.6 |
| Δ E | — | 0.1 | 0.2 | 0.4 | 0.2 | — | 0.4 | 0.6 | 0.8 | 0.8 |

¹Paint I
²3-mil wet drawdown
³Hunter Pro-3 Gloss Meter
⁴Hunter UltraScan XE
⁵11 pounds phthalo blue dispersion

It can be seen that the overall tint strength as measured by the ΔE parameters is modified by the feldspar post-addition compared to that with post addition of TiO₂ alone.

### EXAMPLE 7

This Example shows a comparison of a 75% PVC paint prepared by post-addition of hydrous kaolin as compared with post-addition of TiO₂ alone, as summarized in Table XlI below.

TABLE XII

| Titanium Dioxide Control - 75% PVC | | | | | Hydrous Kaolin - 75% PVC | | | | |
|---|---|---|---|---|---|---|---|---|---|
| Weight (lbs/100 Gallons Paint I) | | | | | | | | | |
| 0¹ | 3.5 | 7.0 | 10.5 | 14.0 | 0¹ | 7.5 | 15.0 | 22.5 | 30.0 |
| PVC After Addition Paint I | | | | | | | | | |
| 75.0% | 75.1% | 75.2% | 75.3% | 75.4% | 75.0% | 75.2% | 75.4% | 75.5% | 75.7% |

Paint² Film Property Summary

| | | | | | | | | | | |
|---|---|---|---|---|---|---|---|---|---|---|
| 60° Gloss³ | 3.0 | 3.0 | 3.0 | 3.0 | 1.3 | 3.0 | 3.1 | 3.0 | 3.0 | 3.0 |
| 85° Sheen³ | 5.4 | 5.2 | 5.0 | 5.0 | 4.6 | 5.4 | 6.1 | 6.1 | 5.4 | 6.1 |
| L⁴ | 95.2 | 95.2 | 95.2 | 95.2 | 95.2 | 95.2 | 95.3 | 95.4 | 95.3 | 95.1 |
| a⁴ | −0.7 | −0.7 | −0.7 | −0.7 | −0.7 | −0.7 | −0.7 | −0.7 | −0.7 | −0.7 |
| b⁴ | 1.3 | 1.3 | 1.3 | 1.3 | 1.3 | 1.3 | 1.4 | 1.4 | 1.4 | 1.3 |
| ASTM-E- | 84.4 | 84.5 | 84.6 | 84.7 | 84.9 | 84.4 | 84.6 | 84.7 | 84.6 | 84.3 |
| 313 White⁴ | | | | | | | | | | |
| ASTM-E- | 2.0 | 2.0 | 2.0 | 1.9 | 1.9 | 2.1 | 2.1 | 2.1 | 2.1 | 2.1 |
| 313 | | | | | | | | | | |
| Yellow⁴ | | | | | | | | | | |
| Brightness⁴ | 89.1 | 89.1 | 89.2 | 89.2 | 89.4 | 89.1 | 89.4 | 89.5 | 89.4 | 89.0 |
| Opacity | 97.9 | 98.0 | 98.1 | 98.2 | 98.3 | 97.9 | 99.8 | 98.5 | 98.8 | 98.2 |

Tinted⁵ Film Property Summary

| | | | | | | | | | | |
|---|---|---|---|---|---|---|---|---|---|---|
| L⁴ | 79.3 | 79.3 | 79.3 | 79.3 | 79.3 | 79.3 | 79.0 | 78.8 | 78.7 | 78.4 |
| a⁴ | −9.6 | −9.6 | −9.6 | −9.6 | −9.6 | −9.6 | −9.7 | −9.7 | −9.8 | −9.8 |
| b⁴ | −17.6 | −17.7 | −17.8 | −17.8 | −17.8 | −17.6 | −17.9 | −18.1 | −18.4 | −18.6 |
| Δ L | — | 0.0 | 0.0 | 0.0 | 0.0 | — | 0.3 | 0.5 | 0.6 | 0.9 |
| Δ a | — | 0.0 | 0.0 | 0.3 | 0.0 | — | 0.1 | 0.1 | 0.2 | 0.2 |
| Δ b | — | 0.1 | 0.2 | 0.2 | 0.2 | — | 0.3 | 0.7 | 0.8 | 1.0 |
| Δ E | — | 0.1 | 0.2 | 0.4 | 0.2 | — | 0.5 | 0.8 | 1.1 | 1.4 |

¹Paint I
²3-mil wet drawdown
³Hunter Pro-3 Gloss Meter
⁴Hunter UltraScan XE
⁵11 pounds phthalo blue dispersion

It can be seen that the overall tint strength as measured by the ΔE parameter is improved by the hydrous kaolin post-addition compared to that of post addition of TiO₂ alone.

### EXAMPLE 8

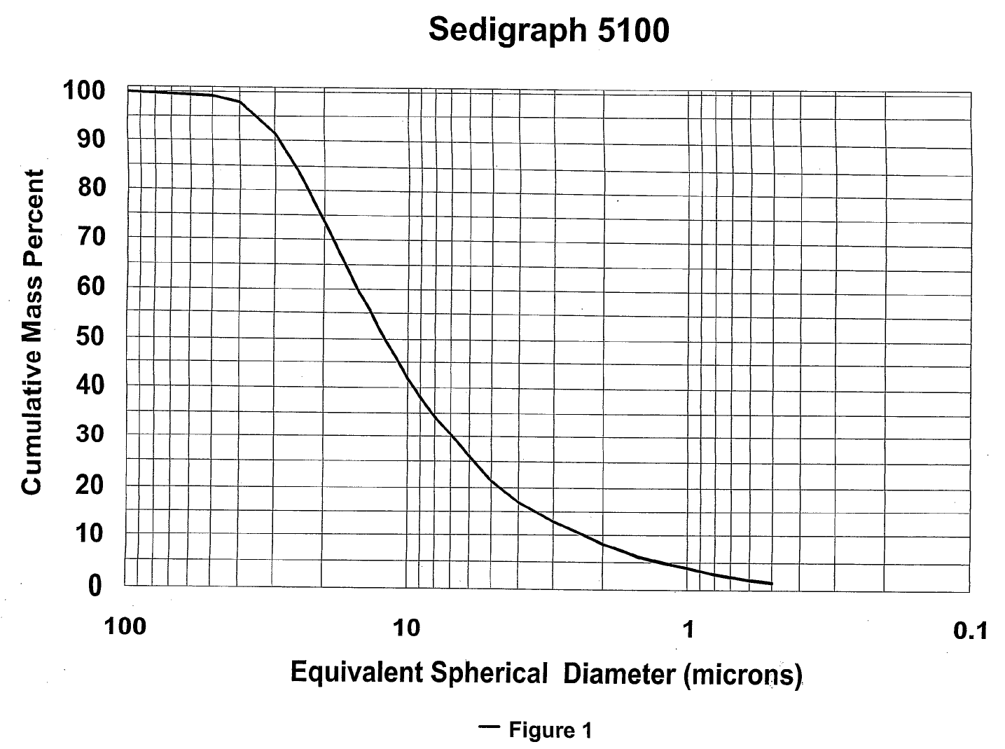

This example describes a comparison between post-addition with TiO₂ versus post-addition with a blend of calcined kaolin and calcium carbonate in 44% PVC and 65% PVC paints. The particle size distribution for the calcium carbonate used in this example is illustrated in FIG. 1. FIG. 1 shows a graph of equivalent spherical diameter (Δm, x-axis), as measured by a Sedigraph 5100, versus cumulative mass percent (y-axis). The calcined kaolin used in this Example was a fully calcined Georgia kaolin having the following particle size distribution: 97.5% less than 10 Δm, 86.1% less than 5 Δm, 62.8% less than 2 Δm, 50.7% less than 1 Δm, and 28.8% less than 0.5 Δm. Post-addition was also carried out with a delaminated Georgia kaolin as a control..

A 44% PVC paint was prepared according to the formulation of Table I in Example 1. The optical data from the post-addition studies are shown in Tables XII-XVII, below. Post-addition was carried out with the following white minerals: 100% TiO₂ (Table XIII), a blend of 87.5% calcined kaolin and 12.5% calcium carbonate (Table XIV), a blend of 75% calcined kaolin and 25% calcium carbonate (Table XV), 100% delaminated kaolin (Table XVI), and 100% calcined kaolin (Table XVII).

A 65% PVC paint was prepared according to the formulation of Table I in Example 1. The optical data from the post-addition studies are shown in Tables XVIII - XXII, below. Post-addition was carried out with the following white minerals: 100% TiO₂ (Table XVIII), a blend of 87.5% calcined kaolin and 12.5% calcium carbonate (Table XIX), a blend of 75% calcined kaolin and 25% calcium carbonate (Table XX), 100% delaminated kaolin (Table XXI), and 100% calcined kaolin (Table XXII).

### 44% PVC

TABLE XIII

| | | | | | |
|---|---|---|---|---|---|
| TiO₂ Post-Addition¹ | 0 | 7.25 | 14.5 | 21.75 | 29 |

Paint Film Properties

| | | | | | |
|---|---|---|---|---|---|
| 60° Gloss | 2.9 | 2.9 | 2.9 | 2.9 | 2.9 |
| 85° Sheen | 3.1 | 3.3 | 3.3 | 3.3 | 3.2 |
| L | 93.9 | 94.0 | 94.1 | 94.2 | 94.3 |
| a | −0.9 | −0.9 | −0.9 | −0.9 | −0.9 |
| b | 1.7 | 1.6 | 1.6 | 1.6 | 1.5 |
| ASTM-E-313 White | 80.2 | 80.8 | 81.2 | 81.5 | 82.0 |
| ASTM-E-313 Yellow | 2.7 | 2.5 | 2.4 | 2.4 | 2.2 |
| Brightness | 86.3 | 86.6 | 86.9 | 87.1 | 87.4 |
| Opacity | 89.3 | 90.7 | 91.4 | 91.8 | 92.6 |

Tinted Film Properties

| | | | | | |
|---|---|---|---|---|---|
| L | 74.1 | 74.7 | 74.4 | 75.0 | 75.2 |
| a | −10.9 | −10.7 | −10.8 | −10.6 | −10.6 |
| b | −21.8 | −21.5 | −21.6 | −21.1 | −21.1 |
| Δ L | — | −0.6 | −0.3 | −0.8 | −1.1 |
| Δ a | — | −0.2 | −0.1 | −0.3 | −0.3 |
| Δ b | — | −0.3 | −0.2 | −0.7 | −0.7 |
| Δ E | — | 0.7 | 0.3 | 1.1 | 1.3 |

¹Post-Add, pounds/100 gallons of paint

TABLE XIV

| 87.5% calcined kaolin/12.5% calcium | | | | | |
|---|---|---|---|---|---|
| carbonate Post-Addition¹ | 0 | 7.25 | 14.5 | 21.75 | 29 |

Paint Film Properties

| | | | | | |
|---|---|---|---|---|---|
| 60° Gloss | 2.9 | 2.9 | 2.9 | 2.9 | 2.8 |
| 85° Sheen | 3.1 | 3.2 | 3.2 | 3.4 | 3.5 |
| L | 93.9 | 93.8 | 94.0 | 94.1 | 94.1 |
| a | −0.9 | −0.9 | −0.9 | −0.9 | −0.9 |
| b | 1.7 | 1.7 | 1.7 | 1.6 | 1.6 |
| ASTM-E-313 White | 80.2 | 80.2 | 80.5 | 80.9 | 81.1 |
| ASTM-E-313 Yellow | 2.7 | 2.7 | 2.6 | 2.6 | 2.5 |
| Brightness | 86.3 | 86.2 | 86.6 | 86.7 | 86.9 |
| Opacity | 89.3 | 91.0 | 90.7 | 91.4 | 91.8 |

Tinted Film Properties

| | | | | | |
|---|---|---|---|---|---|
| L | 74.1 | 74.2 | 74.6 | 74.7 | 75.4 |
| a | −10.9 | −10.8 | −10.8 | −10.7 | −10.7 |
| b | −21.8 | −21.7 | −21.3 | −21.3 | −20.7 |
| Δ L | 0.0 | −0.1 | −0.4 | −0.6 | −1.3 |
| Δ a | 0.0 | −0.1 | −0.1 | −0.2 | −0.2 |
| Δ b | 0.0 | −0.2 | −0.5 | −0.5 | −1.1 |
| Δ E | 0.0 | 0.2 | 0.7 | 0.8 | 1.7 |

¹Post-Add, pounds/100 gallons of paint

TABLE XV

| 75% calcined kaolin/25% calcium | | | | | |
|---|---|---|---|---|---|
| carbonate Post-Addition¹ | 0 | 7.25 | 14.5 | 21.75 | 29 |

Paint Film Properties

| | | | | | |
|---|---|---|---|---|---|
| 60° Gloss | 2.9 | 2.9 | 2.9 | 2.9 | 2.8 |
| 85° Sheen | 3.1 | 3.2 | 3.1 | 3.2 | 3.2 |
| L | 93.9 | 94.0 | 94.0 | 94.0 | 94.1 |
| a | −0.9 | −0.9 | −0.9 | −0.9 | −0.9 |
| b | 1.7 | 1.7 | 1.7 | 1.7 | 1.7 |
| ASTM-E-313 White | 80.2 | 80.4 | 80.4 | 80.6 | 80.9 |
| ASTM-E-313 Yellow | 2.7 | 2.6 | 2.7 | 2.6 | 2.6 |
| Brightness | 86.3 | 86.5 | 86.5 | 86.6 | 86.8 |
| Opacity | 89.3 | 90.9 | 90.8 | 91.0 | 91.8 |

Tinted Film Properties

| | | | | | |
|---|---|---|---|---|---|
| L | 74.1 | 74.1 | 74.3 | 74.5 | 75.1 |
| a | −10.9 | −10.9 | −10.8 | −10.7 | −10.7 |
| b | −21.8 | −21.7 | −21.7 | −21.5 | −21.1 |
| Δ L | 0.0 | 0.1 | −0.2 | 0.4 | −1.0 |
| Δ a | 0.0 | 0.0 | −0.1 | −0.2 | −0.2 |
| Δ b | 0.0 | −0.1 | −0.1 | −0.3 | −0.8 |
| Δ E | 0.0 | 0.2 | 0.2 | 0.5 | 1.2 |

¹Post-Add, pounds/100 gallons of paint

TABLE XVI

| Delaminated kaolin | | | | | |
|---|---|---|---|---|---|
| Post-Addition¹ | 0 | 7.25 | 14.5 | 21.75 | 29 |

Paint Film Properties

| | | | | | |
|---|---|---|---|---|---|
| 60° Gloss | 2.9 | 3.0 | 3.0 | 3.0 | 2.8 |
| 85° Sheen | 3.1 | 3.4 | 3.3 | 3.2 | 3.3 |
| L | 93.9 | 93.9 | 93.9 | 94.0 | 93.7 |
| a | −0.9 | −0.9 | −0.9 | −0.9 | −0.9 |
| b | 1.7 | 1.8 | 1.8 | 1.7 | 1.8 |
| ASTM-E-313 White | 80.2 | 79.6 | 79.9 | 80.2 | 79.1 |
| ASTM-E-313 Yellow | 2.7 | 2.9 | 2.8 | 2.7 | 3.0 |
| Brightness | 86.3 | 86.2 | 86.2 | 86.4 | 85.7 |
| Opacity | 89.3 | 91.2 | 90.8 | 91.1 | 90.6 |

Tinted Film Properties

| | | | | | |
|---|---|---|---|---|---|
| L | 74.1 | 74.1 | 74.0 | 74.3 | 74.2 |
| a | −10.9 | −10.9 | −10.9 | −10.6 | −10.9 |
| b | −21.8 | −21.7 | −21.8 | −21.8 | −21.5 |
| Δ L | 0.0 | 0.0 | 0.1 | −0.1 | 0.0 |
| Δ a | 0.0 | 0.0 | 0.0 | −0.3 | 0.0 |
| Δ b | 0.0 | −0.1 | 0.0 | 0.0 | −0.3 |
| Δ E | 0.0 | 0.1 | 0.1 | 0.3 | 0.3 |

¹Post-Add, pounds/100 gallons of paint

TABLE XVII

| Calcined kaolin | | | | | |
|---|---|---|---|---|---|
| Post-Addition¹ | 0 | 7.25 | 14.5 | 21.75 | 29 |

Paint Film Properties

| | | | | | |
|---|---|---|---|---|---|
| 60° Gloss | 2.9 | 2.9 | 2.9 | 2.9 | 2.8 |
| 85° Sheen | 3.1 | 3.2 | 3.2 | 3.5 | 3.7 |
| L | 93.9 | 94.0 | 94.0 | 94.1 | 94.3 |
| a | −0.9 | −1.0 | −0.9 | −0.9 | −0.9 |
| b | 1.7 | 1.8 | 1.7 | 1.6 | 1.6 |
| ASTM-E-313 White | 80.2 | 80.9 | 80.6 | 81.0 | 81.4 |
| ASTM-E-313 Yellow | 2.7 | 2.8 | 2.6 | 2.6 | 2.5 |
| Brightness | 86.3 | 87.4 | 86.6 | 86.9 | 87.2 |
| Opacity | 89.3 | 89.6 | 91.1 | 92.3 | 92.2 |

Tinted Film Properties

| | | | | | |
|---|---|---|---|---|---|
| L | 74.1 | 74.2 | 74.7 | 74.9 | 75.7 |
| a | −10.9 | −10.8 | −10.8 | −10.7 | −10.6 |
| b | −21.8 | −21.6 | −21.2 | −21.0 | −20.5 |
| Δ L | 0.0 | −0.1 | −0.6 | −0.8 | −1.6 |
| Δ a | 0.0 | −0.1 | −0.1 | −0.2 | −0.3 |
| Δ b | 0.0 | −0.2 | −0.6 | −0.8 | −1.3 |
| Δ E | 0.0 | 0.3 | 0.8 | 1.1 | 2.1 |

¹Post-Add, pounds/100 gallons of paint

### 65% PVC

TABLE XVIII

| | | | | | |
|---|---|---|---|---|---|
| TiO₂ Post-addition¹ | 0 | 7.25 | 14.5 | 21.75 | 29 |

Paint Film Properties

| | | | | | |
|---|---|---|---|---|---|
| 60° Gloss | 2.9 | 2.8 | 2.8 | 3.0 | 3.0 |
| 85° Sheen | 2.1 | 1.8 | 1.8 | 2.0 | 2.1 |
| L | 94.2 | 94.3 | 94.5 | 94.6 | 94.7 |
| a | −0.8 | −0.8 | −0.8 | −0.8 | −0.8 |
| b | 1.9 | 1.8 | 1.7 | 1.7 | 1.7 |
| ASTM-E-313 White | 80.0 | 80.6 | 81.2 | 81.7 | 81.9 |
| ASTM-E-313 Yellow | 3.1 | 2.9 | 2.8 | 2.7 | 2.7 |
| Brightness | 86.5 | 87.0 | 87.3 | 87.6 | 87.8 |
| Opacity | 91.9 | 92.7 | 93.6 | 93.7 | 93.5 |

Tinted Film Properties

| | | | | | |
|---|---|---|---|---|---|
| L | 74.2 | 75.1 | 75.8 | 76.3 | 76.4 |
| a | −10.9 | −10.7 | −10.5 | −10.3 | −10.2 |
| b | −21.7 | −21.0 | −20.4 | −19.9 | −19.9 |
| Δ L | — | −0.9 | −1.6 | −2.1 | −2.2 |
| Δ a | — | −0.2 | −0.5 | −0.7 | −0.8 |
| Δ b | — | −0.7 | −1.3 | −1.8 | −1.9 |
| Δ E | — | 1.1 | 2.1 | 2.9 | 3.0 |

¹Post-Add, pounds/100 gallons of paint

TABLE XIX

| 87.5% calcined kaolin/12.5% calcium | | | | | |
|---|---|---|---|---|---|
| carbonate Post-Addition¹ | 0 | 7.25 | 14.5 | 21.75 | 29 |

Paint Film Properties

| | | | | | |
|---|---|---|---|---|---|
| 60° Gloss | 2.9 | 2.8 | 2.8 | 2.8 | 3.1 |
| 85° Sheen | 2.1 | 1.8 | 1.8 | 2.0 | 2.3 |
| L | 94.2 | 94.3 | 94.2 | 94.3 | 94.4 |
| a | −0.8 | −0.8 | −0.8 | −0.8 | −0.8 |
| b | 1.9 | 1.8 | 1.8 | 1.8 | 1.8 |
| ASTM-E-313 White | 80.0 | 80.3 | 80.4 | 80.7 | 80.8 |
| ASTM-E-313 Yellow | 3.1 | 3.0 | 3.0 | 2.9 | 2.9 |
| Brightness | 86.5 | 86.8 | 86.7 | 87.0 | 87.1 |
| Opacity | 91.9 | 92.4 | 92.3 | 92.9 | 93.9 |

Tinted Film Properties

| | | | | | |
|---|---|---|---|---|---|
| L | 74.2 | 74.5 | 75.1 | 75.7 | 76.1 |
| a | −10.9 | −10.8 | −10.7 | −10.4 | −10.3 |
| b | −21.7 | −21.5 | −20.9 | −20.2 | −19.9 |
| Δ L | — | −0.3 | −0.9 | −1.6 | −1.9 |
| Δ a | — | −0.1 | −0.3 | −0.5 | −0.6 |
| Δ b | — | −0.2 | −0.8 | −1.5 | −1.8 |
| Δ E | — | 0.4 | 1.2 | 2.2 | 2.7 |

¹Post-Add, pounds/100 gallons of paint

TABLE XX

| 75% calcined kaolin/25% calcium | | | | | |
|---|---|---|---|---|---|
| carbonate Post-Addition¹ | 0 | 7.25 | 14.5 | 21.75 | 29 |

Paint Film Properties

| | | | | | |
|---|---|---|---|---|---|
| 60° Gloss | 2.9 | 2.7 | 2.8 | 2.8 | 3.1 |
| 85° Sheen | 2.1 | 1.8 | 1.9 | 1.9 | 2.2 |
| L | 94.2 | 94.3 | 94.2 | 94.4 | 94.4 |
| a | −0.8 | −0.8 | −0.8 | −0.8 | −0.8 |
| b | 1.9 | 1.8 | 1.8 | 1.8 | 1.8 |
| ASTM-E-313 White | 80.0 | 80.3 | 80.3 | 80.7 | 80.9 |
| ASTM-E-313 Yellow | 3.1 | 3.0 | 3.0 | 2.9 | 2.9 |
| Brightness | 86.5 | 86.8 | 86.7 | 87.0 | 87.1 |
| Opacity | 91.9 | 92.1 | 92.8 | 93.3 | 93.5 |

Tinted Film Properties

| | | | | | |
|---|---|---|---|---|---|
| L | 74.2 | 74.6 | 74.6 | 74.9 | 75.2 |
| a | −10.9 | −10.7 | −10.8 | −10.7 | −10.5 |
| b | −21.7 | −21.3 | −21.3 | −21.1 | −20.8 |
| Δ L | — | −0.4 | −0.4 | −0.7 | −1.0 |
| Δ a | — | −0.2 | −0.2 | −0.3 | −0.4 |
| Δ b | — | −0.4 | −0.4 | −0.6 | −0.9 |
| Δ E | — | 0.6 | 0.6 | 1.0 | 1.4 |

¹Post-Add, pounds/100 gallons of paint

TABLE XXI

| | | | | | |
|---|---|---|---|---|---|
| Delaminated kaolin Post-Addition¹ | 0 | 7.25 | 14.5 | 21.75 | 29 |

Paint Film Properties

| | | | | | |
|---|---|---|---|---|---|
| 60° Gloss | 2.9 | 2.7 | 2.8 | 2.8 | 3.1 |
| 85° Sheen | 2.1 | 1.7 | 1.7 | 1.8 | 2.1 |
| L | 94.2 | 94.1 | 94.2 | 94.3 | 94.3 |
| a | −0.8 | −0.8 | −0.8 | −0.8 | −0.8 |
| b | 1.9 | 1.9 | 1.9 | 1.9 | 2.0 |
| ASTM-E-313 White | 80.0 | 79.9 | 80.0 | 79.9 | 79.7 |
| ASTM-E-313 Yellow | 3.1 | 3.1 | 3.1 | 3.2 | 3.3 |
| Brightness | 86.5 | 86.5 | 86.6 | 86.6 | 86.6 |
| Opacity | 91.9 | 92.6 | 92.1 | 92.5 | 92.8 |

Tinted Film Properties

| | | | | | |
|---|---|---|---|---|---|
| L | 74.2 | 74.7 | 74.9 | 75.3 | 75.5 |
| a | −10.9 | −10.8 | −10.7 | −10.6 | −10.6 |
| b | −21.7 | −21.3 | −20.9 | −20.5 | −20.2 |
| Δ L | — | −0.5 | −0.7 | −1.1 | −1.3 |
| Δ a | — | −0.2 | −0.2 | −0.4 | −0.4 |
| Δ b | — | −0.4 | −0.8 | −1.3 | −1.5 |
| Δ E | — | 0.7 | 1.1 | 1.7 | 2.0 |

¹Post-Add, pounds/100 gallons of paint

TABLE XXII

| | | | | | |
|---|---|---|---|---|---|
| Calcined kaolin Post-Addition¹ | 0 | 7.25 | 14.5 | 21.75 | 29 |

Paint Film Properties

| | | | | | |
|---|---|---|---|---|---|
| 60° Gloss | 2.9 | 2.8 | 2.8 | 2.8 | 3.0 |
| 85° Sheen | 2.1 | 1.8 | 1.9 | 2.1 | 2.4 |
| L | 94.2 | 94.2 | 94.3 | 94.5 | 94.6 |
| a | −0.8 | −0.8 | −0.8 | −0.8 | −0.8 |
| b | 1.9 | 1.8 | 1.8 | 1.8 | 1.7 |
| ASTM-E-313 White | 80.0 | 80.1 | 80.5 | 81.0 | 81.5 |
| ASTM-E-313 Yellow | 3.1 | 3.0 | 3.0 | 2.9 | 2.8 |
| Brightness | 86.5 | 86.6 | 86.9 | 87.2 | 87.6 |
| Opacity | 91.9 | 92.4 | 93.3 | 93.9 | 94.1 |

Tinted Film Properties

| | | | | | |
|---|---|---|---|---|---|
| L | 74.2 | 75.2 | 75.7 | 76.3 | 76.4 |
| a | −10.9 | −10.6 | −10.4 | −10.2 | −10.2 |
| b | −21.7 | −20.9 | −20.3 | −19.8 | −19.6 |
| Δ L | — | −1.0 | −1.6 | −2.1 | −2.2 |
| Δ a | — | −0.3 | −0.5 | −0.7 | −0.7 |
| Δ b | — | −0.9 | −1.4 | −1.9 | −2.1 |
| Δ E | — | 1.3 | 2.2 | 2.9 | 3.1 |

¹Post-Add, pounds/100 gallons of paint

It can be seen that post-addition with the blends results in an overall tint strength as measured by the ΔE parameter, that is improved or comparable to that of post addition of TiO₂ or delaminated alone. Moreover, the blends maintain a lower 85° sheen compared to post-addition with calcined kaolin alone.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention.

Other aspects of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A process for preparing a paint, comprising:
providing a first paint having at least one optical property chosen from tint strength, color, opacity, and whiteness; and
combining at least one white pigment with the first paint in an amount effective to form a second paint having at least one optical property of a different value from the at least one optical property of the first paint;
wherein the at least one white pigment includes a white pigment other than TiO₂.

2. The process according to claim 1, wherein the white pigment other than TiO₂ is chosen from plastic pigments and white minerals.

3. The process according to claim 1, wherein the white pigment other than TiO₂ is in slurry form.

4. The process according to claim 2, wherein the white minerals are chosen from silica, calcium sulfate, feldspar, limestone, dolomite, chalk, brucite, halloysite, zeolite, smectite, mica, nephyline syenite, aluminum trihydroxide, alumina, zirconia, lead oxide, lead carbonate, zinc oxide, zinc sulfide, barium sulfate, barite, and aluminum silicate.

5. The process according to claim 2, wherein the white minerals are chosen from white synthetic pigments chosen from precipitated calcium carbonate, precipitated magnesium hydroxide, precipitated silica, precipitated barium sulfate, and synthetic aluminum trihydroxide.

6. The process according to claim 2, wherein the white minerals are wet-ground.

7. The process according to claim 2, wherein the white minerals are dry-ground.

8. The process according to claim 2, wherein the white mineral comprises diatomaceous earth.

9. The process according to claim 8, wherein the diatomaceous earth comprises flux-calcined diatomaceous earth.

10. The process according to claim 2, wherein the white mineral comprises kaolin.

11. The process according to claim 10, wherein the kaolin is chosen from calcined kaolin, hydrous kaolin, and mixtures thereof.

12. The process according to claim 10, wherein the kaolin comprises a delaminated kaolin.

13. The process according to claim 10, wherein the kaolin comprises a partially calcined kaolin.

14. The process according to claim 10, wherein the kaolin comprises a fully calcined kaolin.

15. The process according to claim 10, wherein the kaolin comprises a flash calcined kaolin.

16. The process according to claim 2, wherein the plastic pigments are chosen from homopolymers and copolymers comprising monomers chosen from acrylate monomers, alkyl acrylate monomers, ester monomers, vinyl monomers, and styrene monomers.

17. The process according to claim 2, wherein the white mineral comprises calcium carbonate.

18. The process according to claim 2, wherein the white mineral comprises talc.

19. The process according to claim 2, wherein the white mineral comprises calcium carbonate and calcined kaolin.

20. The process according to claim 2, wherein the white mineral comprises crystalline silicas.

21. The process according to claim 1, wherein the paint has a pigment volume concentration ranging from about 35% to about 50%.

22. The process according to claim 1, wherein the paint has a pigment volume concentration ranging from about 50% to about 60%.

23. The process according to claim 1, wherein the paint has a pigment volume concentration ranging from about 60% to about 70%.

24. The process according to claim 1, wherein the paint has a pigment volume concentration ranging from about 70% to about 85%.

25. The process according to claim 1, wherein the first and second paints are latex paints.

26. The process according to claim 1, wherein the first and second paints are oil-based paints.

27. The process according to claim 1, wherein the first and second paints are acrylic paints.

28. The process according to claim 1, wherein the second paint has a PVC greater than CPVC.

29. The process according to claim 1, wherein the second paint has a PVC below CPVC.

30. The process according to claim 1, wherein the at least one white pigment other than TiO₂ has an oil absorption of at least about 100%.

31. The process according to claim 1, wherein the at least one white pigment other than TiO₂ has an oil absorption of at least about 110%.

32. The process according to claim 1, wherein the at least one optical property of the first and second paints is tint strength.

33. The process according to claim 1, wherein the at least one optical property of the first and second paints is color.

34. The process according to claim 1, wherein the at least one white pigment other than TiO₂ is a blend comprising at least two white pigments.

35. The process according to claim 34, wherein the at least one white pigment other than TiO₂ is a blend comprising at least two white minerals.

36. The process according to claim 35, wherein the blend comprises calcined kaolin and calcium carbonate.

37. The process according to claim 1, further comprising measuring the at least one optical property of the first paint prior to the combining.

38. The process according to claim 37, further comprising determining an amount of the at least one white pigment for combining with the first paint, based on the measured at least one optical property.

39. A paint prepared by the process according to claim 1.

40. A process for preparing a paint, comprising:
providing a first paint having at least one optical property, the first paint having a pigment volume concentration ranging from about 50% to about 60% and the at least one optical property being chosen from tint strength, opacity, color, and whiteness;
combining talc with the first paint in an amount effective to form a second paint having at least one optical property of a different value from the at least one optical property of the first paint.

41. The process according to claim 40, wherein the at least one optical property of the first and second paints is tint strength.

42. A process for preparing a paint, comprising:
providing a first paint having at least one optical property, the first paint having a pigment volume concentration ranging from about 35% to about 70% and the at least one optical property being chosen from tint strength, opacity, color, and whiteness;
combining calcined kaolin with the first paint in an amount effective to form a second paint having at least one optical property of a different value from the at least one optical property of the first paint.

43. The process according to claim 42, wherein the at least one optical property of the first and second paints is tint strength.

44. A process for preparing a paint, comprising:
providing a first paint having at least one optical property, the first paint having a pigment volume concentration of at least about 70% and the at least one optical property being chosen from tint strength, opacity, color, and whiteness;
combining hydrous kaolin with the first paint in an amount effective to form a second paint having at least one optical property of a different value from the at least one optical property of the first paint.

45. The process according to claim 44, wherein the at least one optical property of the first and second paints is tint strength.

46. A process for preparing a paint, comprising:
providing a first paint having at least one optical property, the paint having a pigment volume concentration ranging from about 60% to about 70% and the at least one optical property being chosen from tint strength, opacity, color, and whiteness;
combining calcium carbonate with the first paint in an amount effective to form a second paint having at least one optical property of a different value from the at least one optical property of the first paint.

47. The process according to claim 46, wherein the at least one optical property of the first and second paints is tint strength.

48. A process for preparing a paint, comprising:
providing a first paint having at least one optical property, the first paint having a pigment volume concentration of at least about 70% and the at least one optical property being chosen from tint strength, opacity, color, and whiteness;
combining feldspar with the first paint in an amount effective to form a second paint having at least one optical property of a different value from the at least one optical property of the first paint.

49. The process according to claim 48, wherein the at least one optical property of the first and second paints is tint strength.

50. A process for preparing a paint, comprising:
providing a first paint having at least one optical property, the first paint having a pigment volume concentration of at least about 70% and the at least one optical property being chosen from tint strength, opacity, color, and whiteness;
combining calcium carbonate and kaolin with the first paint in an amount effective to form a second paint having at least one optical property of a different value from the at least one optical property of the first paint.

51. The process according to claim 50, wherein said kaolin comprises a calcined kaolin.

52. The process according to claim 50, wherein the at least one optical property of the first and second paints is tint strength.

53. The process according to claim 50, wherein the at least one optical property of the first and second paints is color.

54. The process according to claim 53, wherein the color of the second paint is lightened compared to the color of the first paint.

55. A process for preparing a PVC tinted system, comprising:
providing a first medium having at least one optical property chosen from tint strength, opacity, color, and whiteness; and
combining at least one white pigment with the first medium in an amount effective to form a second medium having at least one optical property of a different value from the at least one optical property of the first medium;
wherein the at least one white pigment includes a white pigment other than TiO₂.

56. The process according to claim 55, wherein the first and second media are chosen from paints, inks, colorable sealants, colorable caulks, grout, synthetic stucco, block filler, and plastics.
